(19) United States
(12) Patent Application Publication
(10) Pub. No.: US 2011/0290966 A1
(43) Pub. Date: Dec. 1, 2011

(54) CURTAIN HANGING DEVICE

(76) Inventor: Harunori OTA, Maebashi-shi (JP)

(21) Appl. No.: 13/117,798

(22) Filed: May 27, 2011

(30) Foreign Application Priority Data
May 28, 2010 (JP) 003607/2010

(51) Int. Cl. F16M 13/02; F16B 45/00

(52) U.S. Cl. 248/215; 248/214

(57) ABSTRACT

A curtain hanging device that works as usual when the curtain is used without problems and that can prevent an accident from happening when the curtain is accidentally tangled around the neck of a person is disclosed.

Curtain Hanging Device 1 of the invention comprises Coupler 2 for suspending Curtain A from a curtain rail, wherein Coupler 2 has a catch for hanging from the rail, or Coupler 2 itself forms the catch, and wherein the catch deforms to release Curtain A from the rail when an extra load is applied to Curtain A.

### TECHNICAL FIELD

The present invention relates to a curtain hanging device that is capable of releasing the curtain from the curtain rail when an extra load is applied to the curtain.

### BACKGROUND ART

A typical curtain is suspended from a curtain rail above the interior side of a window and is movably attached to the curtain runners mounted on the rail. Generally, a curtain is tightly attached to the rings of the runners via hooks made of metal, plastic, or the like to prevent the curtain from being easily removed from the runners when a load is applied

As described above, a conventional curtain is more or less tightly attached to a curtain rail. Recently, however, tight attachment of a curtain to a curtain rail can cause problems. The problems include, for example, deaths attributed to blocking of carotid arteries by a curtain. Generally, hanging oneself is less likely to cause choking, but mostly causes death by using the weight of the body to tighten the trachea with the curtain. The arteries (carotid and vertebral arteries) are blocked and the blood flow to the brain is reduced, which causes brain anoxia (acute anemia) and subsequent syncope, resulting in death. Therefore, blocking of the arteries by a curtain can cause death even when not all of the body weight is applied.

Such accidents occur in a wide age range of people from children to the elderly. And the accidents also occur in special medical facilities (facilities for mentally challenged persons), facilities for protecting young people, juvenile classification offices (reform schools), and the like, as well as the home.

Patent Document 1 describes a runner for a curtain rail divided into a slider part and a curtain part, wherein the slider part and the curtain part are connected with a magnet to allow the curtain part to be easily detachable. This magnetic runner for a curtain rail enables the elderly, women, and children with less physical power to easily detach a curtain. For example, Patent Document 1 describes that the runner enables the users to use a curtain at hand as an emergency supply if a disaster occurs.

### RELATED ART DOCUMENT

### Patent Document

Patent Document 1: Japanese Unexamined Patent Application Publication No. 2008-86544 (such as Claims)

### SUMMARY OF THE INVENTION

### Problem to be Solved by the Invention

However, because the magnetic runner for a curtain rail described in Patent Document 1 enables the elderly, women, and children with less physical power to easily detach a curtain, the runner has an problem in that magnetic weakening over time, if only slightly, leads to decrease in suspension strength, with the result that the curtain falls out on its own. Additionally, the magnetic force can cause a negative impact on clocks and electric appliances.

Therefore, an object of the invention is to provide a curtain hanging device which works as usual when the curtain is used without problems and which can prevent an accident from happening when the curtain is accidentally tangled around the neck of a person.

### Means for Solving the Problem

In order to solve the problems as described above, the curtain hanging device of the invention comprises a coupler for suspending a curtain from a curtain rail, wherein the coupler has a catch for hanging from the rail, or the coupler itself forms the catch, and wherein the catch deforms to release the curtain from the rail when an extra load is applied to the curtain.

Now, the preferred embodiments of the invention will be described.

In a preferred embodiment, the catch is formed of an elastically deformable material.

And the coupler is a hook attached to an adjuster.

The coupler has also a ratchet for releasing a curtain when a downward load is applied to the adjuster.

In another preferred embodiment, the coupler is a hook having a curtain holder.

In still another preferred embodiment, the coupler is a ring attached to a curtain runner.

In still another preferred embodiment, a plurality of the couplers is attached to belt like lining.

### Effects of the Invention

The curtain hanging device of the invention works as usual when the curtain is used without problems and can prevent an accident due to blocking of the carotid arteries from happening when the curtain is accidentally tangled around the neck of a person, because the device comprises a catch that deforms to release the curtain from the rail when an extra load is applied to the curtain. Because the catch of the curtain hanging device of the invention is flexibly deformable, a curtain can be machine-washed without removing the coupler.

### BRIEF DESCRIPTION OF THE DRAWINGS

FIGS. 1 (a) and (b) are a view showing how to attach to the adjuster the coupler consisting of a hook having a hook member as a catch in a first embodiment of the curtain hanging device of the invention.

FIG. 2 (a)-(c) are a view showing what happens to the hook of the curtain hanging device shown in FIG. 1 when an extra load is applied.

FIGS. 3 (a) and (b) are a view showing the ratchet of the adjuster in a second embodiment of the curtain hanging device of the invention.

FIG. 4 is a front view showing the ratchet of a conventional adjuster.

FIG. 5 is a partial perspective view showing a third embodiment of the curtain hanging device of the invention.

FIG. 6 (a)-(c) are a view showing what happens to the hook of the curtain hanging device shown in FIG. 5 when an extra load is applied.

FIGS. 7 (a) and (b) are a partial perspective view of a fourth embodiment of the curtain hanging device of the invention.

FIG. 8 is a partial perspective view of a fifth embodiment of the curtain hanging device of the invention.

### DETAILED DESCRIPTION OF THE PREFERRED EMBODIMENTS

Now, the embodiments of the curtain hanging device of the invention will be described with reference to the drawings.

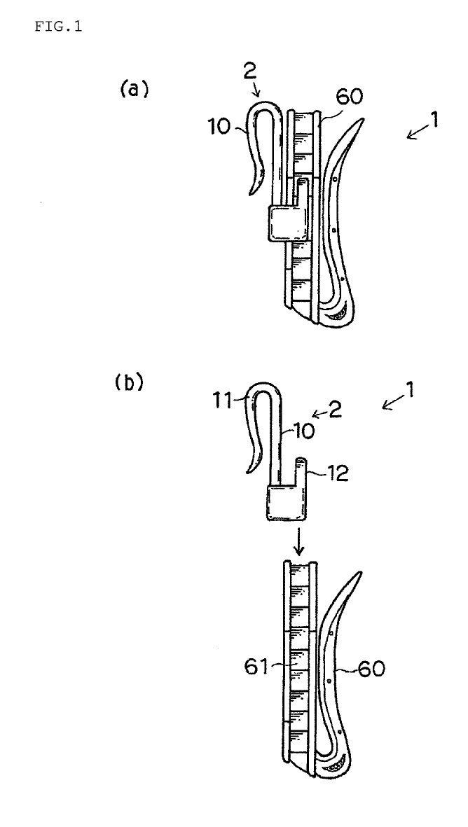

In a first embodiment of the invention, Coupler 2 of Curtain Hanging Device 1 is Hook 10 attached to Adjuster 60 that adjusts the suspension height of a curtain. As shown in FIG. 1(b), Hook 10 consists of Hook Member 11 that is a hairpin catch for hanging from a ring of a curtain rail and Ratchet Member 12 attached to Ratchet 61 of Adjuster 60. Hook Member 11 is formed of a material that elastically deforms without being damaged when an extra load is applied to the curtain. More specifically, the material includes metal such as steel, resin such as polyolefin resin, polyester resin, polycarbonate resin, and polyamide resin, and elastomer.

Because Hook 10 is detachable from Adjuster 60 as shown in FIG. 1(b), it is highly convenient when the curtain is washed and attached again.

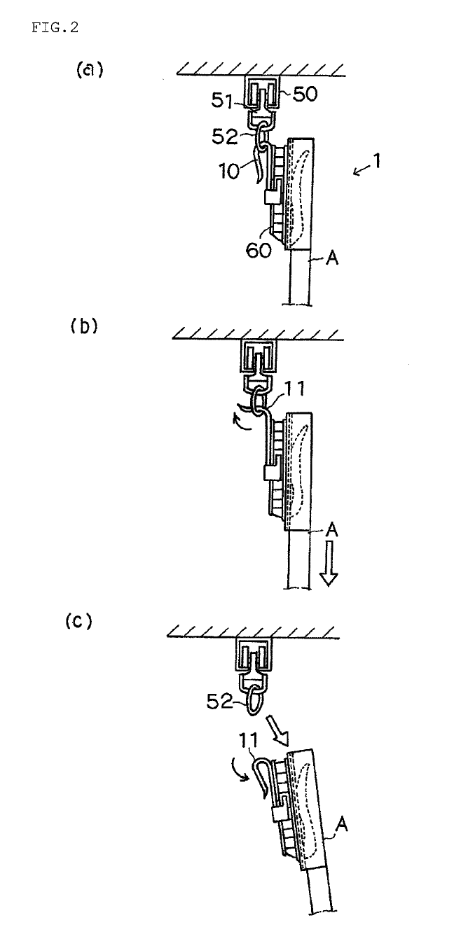

FIGS. 2 (a), (b), and (c) show how to release a curtain from Curtain Hanging Device 1 of which Hook 10 is attached to Adjuster 60.

FIG. 2 (a) shows Curtain Hanging Device 1 that suspends Curtain A attached to Adjuster 60 by engaging Hook 10 on Ring 52 of Runner 51 attached to Curtain Rail 50.

FIG. 2 (b) shows what happens when an extra load is applied to Curtain A. When a load of, for example, about 10 kg is applied to Curtain A, Hook Member 11, which is formed of an elastically deformable material, deforms under the load.

When an additional load is applied to Curtain A, Hook Member 11 further deforms and is removed from Ring 52 to release Curtain A, as shown in FIG. B (c). Accordingly, if Curtain A is accidentally tangled around the neck of a person and a load is applied, Curtain A is released before the carotid arteries are blocked, with the result that an accident can be prevented from happening. Because Hook 10 is formed of an elastically deformable material, the original shape can be immediately recovered when the load is removed. This allows Curtain A to be suspended from Curtain Hanging Device 1 again.

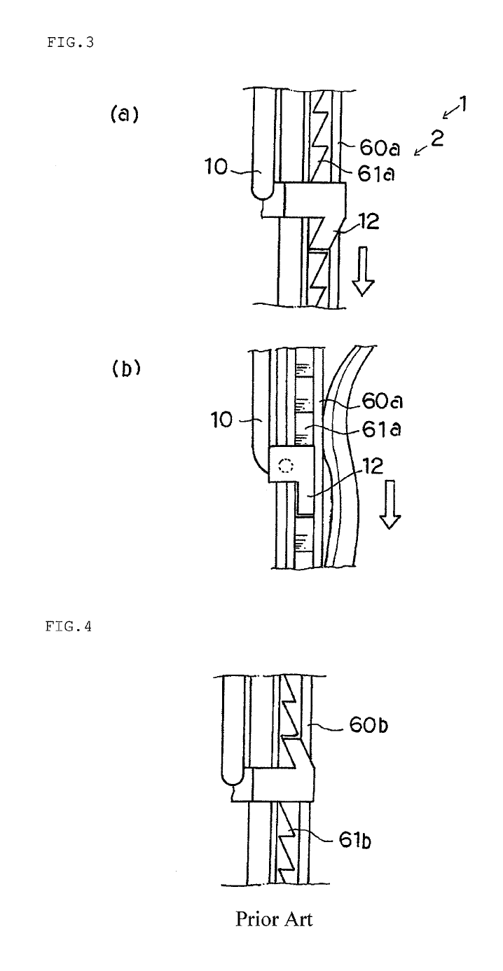

In a second embodiment of the invention, Coupler 2 of Curtain Hanging Device 1 is Adjuster 60 that adjusts the height of the curtain. Adjuster 60a shown in FIG. 3 (a) is configured to allow Adjuster 60a and the curtain to be released when an extra downward load is applied.

As shown in FIG. 4, Ratchet 61b of conventional Adjuster 60b has teeth of which lower line is parallel with the floor. Thus, the hook is engaged on a ring of a curtain runner without permitting the curtain to be easily released.

In contrast, Ratchet 61a of Adjuster 60a in the invention has teeth of which upper line is parallel with the floor. Thus, if Ratchet 61a is engaged with Ratchet Member 12, which is the catch member of Hook 10, and then a downward load is applied, Adjuster 60a is separated from Hook 10, as shown in FIGS. 3 (a) and (b). It means that a certain load allows the curtain to be released. Like Coupler 2 of Curtain Hanging Device 1 in the first embodiment, Ratchet Member 12 as the catch member is formed of a material that elastically deforms without being damaged when an extra load is applied to the curtain. More specifically, the material includes metal such as steel, and resin such as polyolefin resin, polyester resin, polycarbonate resin, and polyamide resin.

Note that FIGS. 3 (a) and (b) are a front view and a side view of Adjuster 60a, respectively.

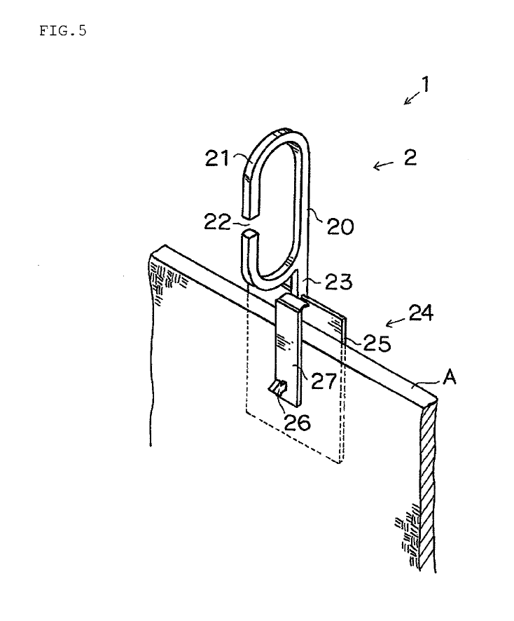

In a third embodiment of the invention, Coupler 2 of Curtain Hanging Device 1 is Hook 20, which has Curtain Holder 24, as shown in FIG. 5. Hook 20 is formed of a material that elastically deforms without being damaged when an extra load is applied to the curtain. More specifically, the material includes metal such as steel, resin such as polyolefin resin, polyester resin, polycarbonate resin, and polyamide resin, and elastomer. Hook 20 consists of oval Hook Body 21 as the catch member, Opening 22 formed in the approximate center of Hook Body 21, and Shaft 23 connecting to Hook Body 21. And Curtain Holder 24 for retaining the upper end of Curtain A is attached to the lower part of Shaft 23.

Curtain Holder 24 consists of Plate 25, Pin 26 standing on Plate 25, and Supporting Member 27 foldably connected to Plate 25. Curtain Holder 24 can retain the upper end of Curtain A by placing the upper end of Curtain A between Plate 25 and Supporting Member 27, pricking Curtain A with Pin 26, and then fitting Pin 26 through a hole in Supporting Member 27.

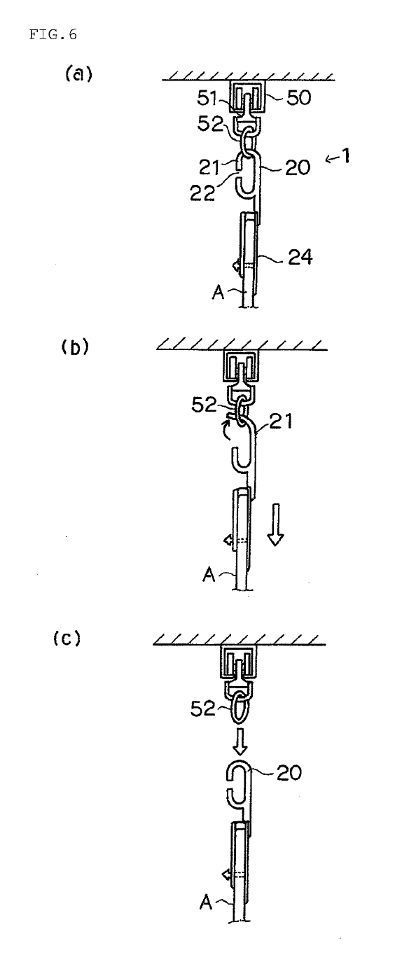

FIGS. 6 (a), (b), and (c) show how Curtain Hanging Device 1 releases Curtain A using Hook 20.

FIG. 6 (a) shows Curtain Hanging Device 1 suspending Curtain A by passing Ring 52 of Runner 51 attached to Curtain Rail 50 through Opening 22 in Hook Body 21.

FIG. 6 (b) shows what happens when a load is applied to Curtain A. Hook Body 21 formed of a material that elastically deforms when a load of, for example, about 10 kg is applied to Curtain A deforms under the load.

When an additional extra load is applied to Curtain A, Hook Body 21 further deforms and then Hook 20 is removed from Ring 52 to release Curtain A, as shown in FIG. 6 (c). Because Hook Body 21 is formed of an elastically deformable material, the original shape can be immediately recovered when the load is removed. This allows the curtain to be suspended again.

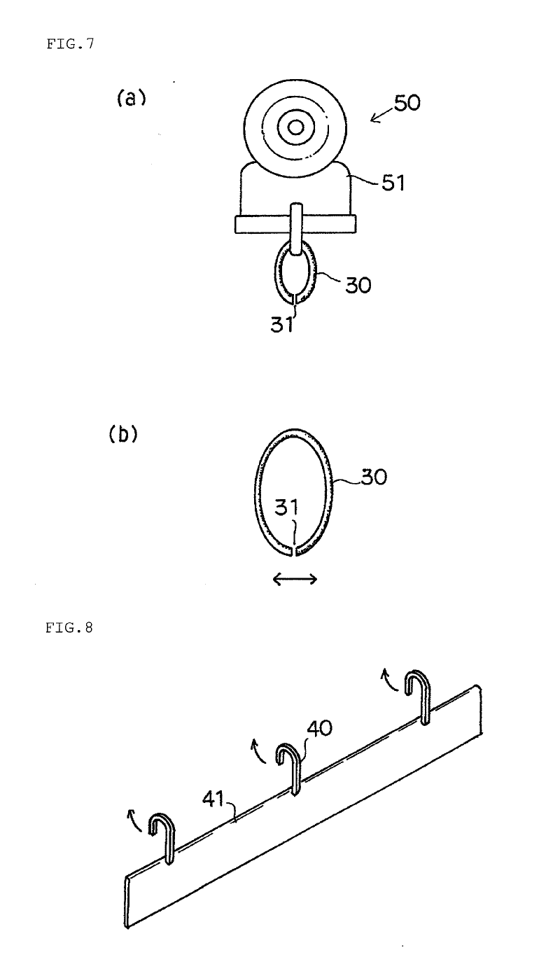

In a fourth embodiment of the invention, Coupler 2 of Curtain Hanging Device 1 is Ring 30 attached to Runner 51, as shown in FIG. 7 (a). Ring 30 is formed of a material that elastically deforms without being damaged when an extra load is applied to the curtain. More specifically, the material includes metal such as steel, resin such as polyolefin resin, polyester resin, polycarbonate resin, and polyamide resin, and elastomer. Ring 30, which functions as a catch, has Opening 31 through which Runner 51 attached to Curtain Rail 50 passes. Because Ring 30 itself, which functions as a catch, is formed of an elastically deformable material, Opening 31 is elastically deformable as shown in FIG. 7 (b). This allows the curtain to be easily released from the curtain rail when an extra load is applied to the curtain.

In a fifth embodiment of the curtain hanging device of the invention, a plurality of couplers is directly attached to bet like Lining 41 sewed to the upper end of the curtain. As shown in FIG. 8, Couplers 40, which function as a catch, are in the form of a hook and are formed of a material that elastically deforms without being damaged when an extra load is applied to the curtain. More specifically, the material includes metal such as steel, resin such as polyolefin resin, polyester resin, polycarbonate resin, and polyamide resin, and elastomer. A plurality of Couplers 40 is directly attached to belt like Lining 41 at equal spaces. Direct sewing of Couplers 40 as part of Lining 41 to the upper end of a curtain allows a plurality of curtain hanging devices to be attached to a curtain rail in a single step.

### DESCRIPTION OF THE REFERENCE NUMERALS

1: Curtain Hanging Device
2: Coupler
10: Hook
11: Hook Member
12: Ratchet Member
20: Hook
21: Hook Body
22: Opening
23: Shaft
24: Curtain Holder
25: Plate
26: Pin
27: Supporting Member
30: Ring
31: Opening
40: Coupler
41: Lining
50: Curtain Rail
51: Runner
52: Ring
60: Adjuster
61: Ratchet
A: Curtain

1. A curtain hanging device comprising a coupler for suspending a curtain from a curtain rail, wherein the coupler has a catch for hanging from the rail, or the coupler itself forms the catch, and wherein the catch deforms to release the curtain from the rail when an extra load is applied to the curtain.

2. The curtain hanging device according to claim 1, wherein the catch elastically deforms.

3. The curtain hanging device according to claim 2, wherein the coupler is attached to an adjuster.

4. The curtain hanging device according to claim 3, wherein the adjuster has a ratchet for releasing a curtain when an extra load is applied to the curtain.

5. The curtain hanging device according to claim 2, wherein the coupler is a hook having a curtain holder.

6. The curtain hanging device according to claim 2, wherein the coupler is a ring attached to a curtain runner.

7. The curtain hanging device according to claim 2, wherein a plurality of the couplers is attached to bet like lining.
